(19) United States
(12) Patent Application Publication
(10) Pub. No.: US 2003/0163318 A1
(43) Pub. Date: Aug. 28, 2003

(54) Compression/decompression technique for speech synthesis

(75) Inventor: Masahiro Serizawa, Tokyo (JP)

Correspondence Address: SCULLY SCOTT MURPHY & PRESSER, PC, 400 GARDEN CITY PLAZA, GARDEN CITY, NY, 11530

(73) Assignee: NEC Corporation, Tokyo (JP)

(21) Appl. No.: 10/376,151

(22) Filed: Feb. 28, 2003

(30) Foreign Application Priority Data
Feb. 28, 2002 (JP) 2002-053063

(51) Int. Cl. G10L 13/00; G10L 13/06

(52) U.S. Cl. 704/264; 704/268

(57) ABSTRACT

A compression/decompression device for speech synthesis allows an increased compression ratio of source signals and improved quality of synthesized speech. The position and amplitude of each pulse for exciting a filer for speech synthesis are calculated based on autocorrelation and cross-correlation. As the number of pulses (k) is increased one by one, an S/N (signal-to-noise ratio) at each pulse number k is successively calculated based on the autocorrelation and the cross-correlation. When the S/N exceeds a preset threshold, the number of pulses is determined and is used for the compression of a speech unit.

### BACKGROUND OF THE INVENTION

1. Field of the Invention

The present invention relates to a speech synthesizing technique such as text-to-speech synthesis, and in particular, to compression/decompression technique of speech unit data for speech synthesis.

2. Description of the Related Art

Speech synthesis by rule is a technique of synthesizing a speech signal according to rules such as phoneme generation information and prosody generation information including duration control information and pitch pattern control information. In the speech synthesis these information are used to select a speech unit from a speech unit database which stores a plurality of speech waveform signals each of which corresponds to a pitch or a phoneme, and then the selected speech units are combined while controlling the pitch and the duration of each speech unit to generate a speech waveform. The quality of the speech synthesis is heavily dependent on the performance of the speech unit database prepared for the speech synthesis. Sound quality of synthesized voice can be improved generally by increasing the number of speech units. Therefore, the scale of a speech unit database becomes an important issue for some devices employing the speech synthesis by rule.

As a method for compressing speech signals efficiently, CELP (Code Excited Linear Prediction) has been known well. The CELP, is elaborated on in, for example, M. R. Schroeder and Bishnu S. Atal “Code-excited linear prediction CELP: High quality speech at very low bit rates,” Proceedings of the 1985 International Conference on Acoustics, Speech, and Signal Processing, volume 1,pages 937-940,March 1985,Institute of Electrical and Electronic Engineers (Document No.1).

The CELP method is also effective for the compression of a voiced speech unit database having pitch periodically. However, the CELP method employing pitch prediction is not suitable for the speech synthesis since an arbitrary part of the speech unit database has to be decompressed in the speech synthesis. The pitch prediction necessitates decoding of the previous decompressed signals, which are not needed for speech synthesis.

To avoid the above problem, there has been proposed a multi-pulse excitation method which does not include the pitch prediction. The method without pitch prediction has been described in, for example, K. Ozawa, S. Ono and T. Araseki, “A study on pulse search algorithms for multi-pulse excited speech coder realization,” IEEE Journal of Selected Areas Communications, vol, SAC-4, No.1, pp.133-141, February 1986 (Document No. 2). In a compression process with the multi-pulse coding, and input signal is analyzed into LP (Linear Prediction) coefficients and an excitation signal, which are compressed separately. The LP coefficients represent spectrum envelope properties of the input signal, which are calculated by conducting LP analysis to the input signal. The excitation signal is used to drive an LP synthesis filter produced from the LP coefficients. The LP analysis and the coding of the LP coefficients are conducted in each of a frame having a predetermined length. The coding of the excitation signal is conducted in units of a sub-frame which is obtained by further speech unitation of the frame. The excitation signal is expressed by a multi-pulse signal including a plurality of pulses (called “excitation code vector”). Meanwhile, in the decompression process, decoded excitation signals are inputted to the synthesis filter obtained from the decoded LP coefficients and thereby the speech signal or audio signal is reproduced.

For example, Fukui (U.S. Pat. No. 5,001,759) discloses a multi-pulse speech coding method capable of coding speech at a bit rate of 16 kbps or less. In this conventional method, pulse search is performed using the cross-correlation and auto-correlation until the actual number of pulses exceeds a predetermined one.

However, the conventional method cannot be applied as it is to a speech synthesizer. In the conventional method, the compression of each speech unit is carried out using a fixed number of pulses regardless of differences among speech units. As a result, the compression ratio of an excitation signal becomes low.

Especially when the sampling rate is high, the accuracy of quantization decreases at high frequencies since the compression process is carried out using a criterion junction having lighter weight in a high-frequency range, which may cause dropouts of a decompressed signal at high frequencies.

Further, even though each input speech unit has been generated so that its both ends will be 0, the both ends of its decompressed speech unit do not necessarily become 0, by which discontinuity occurs when speech units are combined. Such discontinuity deteriorates, the voice quality of synthesized speech.

### SUMMARY OF THE INVENTION

It is an object of the present invention to provide a compression/decompression device and method for speech synthesis capable of realizing increased compression ratio of source signals and improved quality of synthesized speech.

It is another object of the present invention to provide a device and method for speech synthesis allowing the reduced amount of speech unit database.

In accordance with a first aspect of the present invention, there is provided a compression device of speech units for speech synthesis includes: a filter information extractor for extracting information of a filter to be used for speech synthesis from a speech unit; a pulse information extractor for extracting information of pulses for exciting the filter from the speech unit; a controller for determining the number of pulses for each of the speech units depending on characteristics of the speech unit; and an output producer for producing the compressed output signal from the information of the filter, the information of the pulses and the determined number of pulses for each of the speech units.

In accordance with a second aspect of the present invention, there is provided a compression device of speech units for speech synthesis includes: a high-frequency enhancement filter for inputting a speech unit to produce a filtered speech unit; a filter information extractor for extracting information of a filter to be used for speech synthesis from the filtered speech unit; a pulse information extractor for extracting information of pulses for exciting the filter from the filtered speech unit using a weighting function which has inverse characteristics of the high-frequency enhancement filter; and an output producer for producing the compressed output signal from the information of the filter and the information of the pulses.

In accordance with a third aspect of the present invention, there is provided a decompression device of compressed speech units, each of which includes coded information of a filter to be used for speech synthesis, coded information of pulses for exciting the filter, and coded pulse count information of the number of pulses that have been used for compression of an original speech unit, the decompression device includes: a pulse count decoder for decoding the coded pulse count information to produce the number of pulses; and a speech unit decoder for decoding the coded filter information and the coded pulse information based on the number of pulses.

In accordance with a fourth aspect of the present invention, there is provided a decompression device of compressed speech units, each of which is obtained based on a filtered speech unit obtained by high-frequency enhancement filtering of an original speech unit, each of the compressed speech units including coded information of a filter to be used for speech synthesis and coded information of pulses for exciting the filter. The decompression device includes: a speech unit decoder for decoding the coded filter information and the coded pulse information to produce a decompressed speech unit; and a low-frequency enhancement filter for inputting the decompressed speech unit to produce the original speech unit.

In accordance with a fifth aspect of the present invention, there is provided a decompression device of compressed speech units, each of which includes coded information of a filter to be used for speech synthesis and coded information of pulses for exciting the filter. The decompression device includes: a speech unit decoder for decoding the coded filter information and the coded pulse information to produce a decompressed speech unit; and a post-window section for applying a window function to each decompressed speech unit, wherein the window function sets a starting point and endpoint of the decompressed speech unit to zero.

In accordance with a sixth aspect of the present invention, there is provided a decompression device of compressed speech units, each of which includes coded information of a filter to be used for speech synthesis and coded pulse amplitude information and coded pulse position information of pulses for exciting the filter, wherein the coded pulse amplitude information includes coded maximum amplitude information and other coded amplitude information. The decompression device includes: a first decoder for decoding the coded information of the filter to produce information of the filter; a position decoder for decoding the coded pulse position information of the pulses to produce pulse position information of the pulses; and an amplitude decoder for decoding the coded pulse amplitude information of the pulses to produce pulse amplitude information of the pulses, wherein the amplitude decoder comprises: a first decoder having a first table, for decoding the coded maximum amplitude information to produce a maximum amplitude of the pulses; and a plurality of second decoders for decoding the other coded amplitude information to produce amplitudes of each pulse other than the maximum amplitude, wherein each of the second decoders comprises: a plurality of second tables for decoding the other coded amplitude information of a corresponding pulse, wherein each of the plurality of second tables is provided for a different level or a maximum amplitude of pulses; and a selector for selecting one of the plurality of second tables for decoding the other coded amplitude information depending on a level of the decoded maximum amplitude of the pulses.

As described above, according to the present invention, the most suitable number of pulses can be determined for each speech unit based on characteristics of a speech unit, for example, compression quality such as a signal-to-noise ratio SNR etc., and the compression of each speech unit is carried out using the determined number of pulses (which may vary from speech unit to speech unit) by which the total compression ratio can be increased.

Second, a high-frequency enhanced weighting function Wₚᵣₑ (z)=1−z⁻¹ or weighting a high-frequency range is applied to input speech units, and a low-frequency enhanced weighting function W_{percp}(Z)−1/(1−z⁻¹) having inverse characteristics of the aforementioned weighting function is employed in an evaluation function that is used for the calculation of pulse positions and pulse amplitudes. By use of the weights, the speech unit Y(z) is approximated by a signal that is obtained by applying the low-frequency enhanced weight W_{percep}(z) to a reproduced speech unit Ŷ(z) as shown in the following equation, and consequently, the high-frequency range can be weighted in the evaluation of Ŷ(z)

D(z)=W_{percep}(z)[Wₚᵣₑ(z)Y(z)−\hat{Y}(z)]=[Y(z)−W_{precep}(z)\hat{Y}(z)]

Meanwhile, in the decompression processing, the weighting function W_{percep}(z) is applied in order to cancel out the effect of the weighting function Wₚᵣₑ(Z) which has been used in the compression process.

Third, a time window capable of setting the starting point and endpoint of each speech unit to 0 with less influence on voice quality is applied to each synthesized speech unit. As the window, he Hamming window, Hanning window, etc. which are used in LP analysis can be employed, for example. By use of the window, the starting point and endpoint of each synthesized speech unit can be set to 0 and the deterioration of voice quality due to discontinuity can be eliminated.

### BRIEF DESCRIPTION OF THE DRAWINGS

The objects and features of the present invention will become more apparent from the consideration of the following detailed description taken in conjunction with the accompanying drawings, in which:

FIG. 1 is a block diagram schematically showing an example of a speech synthesis system;

FIG. 2 is a block diagram showing a compression section of a speech synthesis system in accordance with a first embodiment of the present invention;

FIG. 3 is a block diagram showing a decompression section of the speech synthesis system in accordance with the first embodiment of the present invention;

FIG. 4 is a block diagram showing a compression section of a speech synthesis system in accordance with a second embodiment of the present invention;

FIG. 5 is a block diagram showing a decompression section of a speech synthesis system in accordance with the second embodiment of the present invention;

FIG. 6 is a block diagram showing a decompression section of a speech synthesis system in accordance with a third embodiment of the present invention;

FIG. 7 is a block diagram showing a decompression section of speech synthesis system in accordance with a fourth embodiment of the present invention; and

FIG. 8 is a block diagram showing the detailed circuit of an amplitude decoder as shown in FIG. 3 and FIG. 7.

### DETAILED DESCRIPTION OF THE PREFERRED EMBODIMENTS

Speech Synthesis System

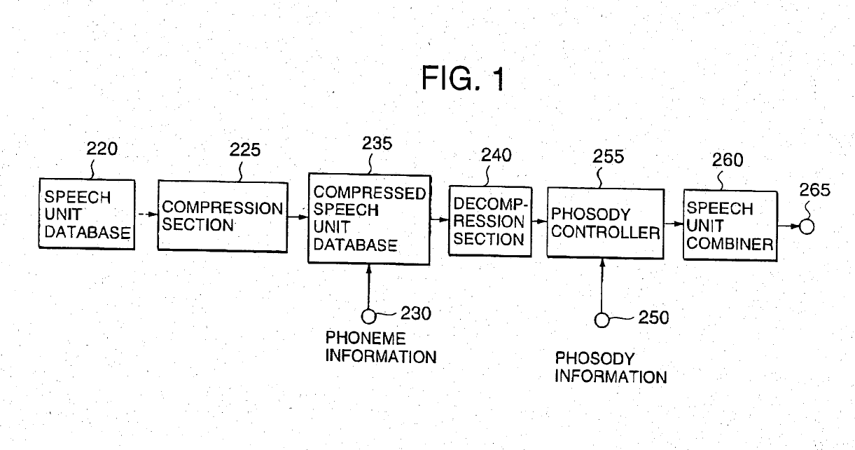

Referring to FIG. 1, a speech synthesis system includes a speech unit database 220, a compression section 225, a compressed speech unit database 235, a decompression section 240, a prosody controller 255, and a speech unit combiner 260. The compression section 225 and the decompression section 240 are designed according to the present invention.

The speech unit database 220 and the compression section 225 are necessary for the generation of the compressed speech unit database 235 which is necessary for the speech synthesis system. The speech unit database 220 previously stores a plurality of speech units which have been cut out from speech signals. The compression section 225 compresses each of the speech units according to the present invention and stores the compressed speech units into the compressed speech unit database 235.

The compressed speech unit database 235 storing the compressed speech units receives phoneme information through its input terminal 230, selects a compressed speech unit according to the phoneme information to output it to the decompression section 240. The decompression section 240 decompresses the compressed speech unit received from the compressed speech unit database 235 according to the present invention and outputs a decompressed speech unit to the prosody controller 255.

The prosody controller 255 controls prosodic features of the decompressed speech unit by use of prosody information received through its input terminal 250. The speech unit combiner 260 combines prosody-controlled speech units received from the prosody controller 255 and outputs a synthesized speech signal through its output terminal 265.

In the speech synthesis system, the compression section 225 may transmit the compressed speech unit data to the compressed speech unit database 235 via a network. The compressed speech unit database 235 may transmit compressed speech unit data selected according to the phoneme information to the decompression section 240 via a network.

First Embodiment

1.1) Compression

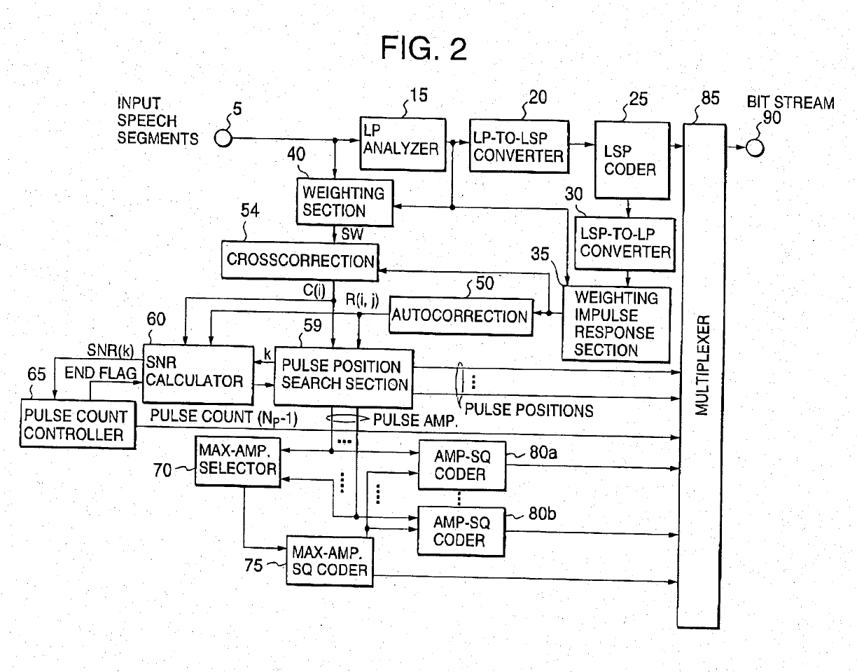

Referring to FIG. 2, a compression section according to a first embodiment of the present invention inputs speech units through an input terminal 5 and outputs a bit stream of compressed speech unit data through an output terminal 90. An input speech unit is provided to an LP analyzer 15 and a weighting section 40.

Filter Information

The LP analyzer 15 perform LP (Linear Prediction) analysis of the input speech unit to calculate LP coefficients. The LP-LSP converter 20 receives the LP coefficients from the LP analyzer 15 and converts them to LSP (Line Spectrum Pair) coefficients.

The LSP coder 25 codes the LSP coefficients to output the coded LSP coefficients to the multiplexer 85. The LSP coder 25 also decodes the coded LSP coefficients to output quantized LSP coefficients to the LSP-LP converter 30.

The coding of the LSP coefficients can be carried out by means of vector quantization, for example. In the vector quantization, both a coder and a decoder are provided with the same vector quantization table. The coder assigns a code to each vector by referring to the vector quantization table and sends it to the decoder. The decoder outputs a vector corresponding to the received code by referring to the vector quantization table. For the details of the vector quantization, see “Efficient Vector Quantization of LPC Parameters at 24 Bits/Frame,” IEEE Proc. ICASSP-91, p. 661-664, 1991.

Impulse Response

The LSP-LP converter 30 converts the quantized LSP coefficients to quantized LP coefficients â(i) (i=1, . . . , p), and sends then to a weighting impulse response section 35. The weighting impulse response section 35 forms a weighting synthesis filter Hw(z) as represented by Equation (1) by use of the quantized LP coefficients â(i) (i=1, . . . , p) received from the LSP-LP converter 30 and the LP coefficients a(i) (i=1, . . . , p) received from the LP analyzer 15, and calculates the impulse response of the weighting synthesis filter Hw(z).

$$Hw ( z ) = \frac{1}{1 + {\sum }_{j = 1}^{p} \hat{a} ( j ) {z}^{- 1}} \cdot \frac{1 + {\sum }_{i = 1}^{p} {β}^{i} a ( i ) {z}^{- i}}{1 + {\sum }_{j = 1}^{p} {γ}^{i} a ( j ) {z}^{- 1}} \qquad ( 1 )$$

In the equation (1), p is the order of LP analysis, and β and γ are coefficients satisfying 0<γ<β≧1, which are used for adjusting the weighting to improve auditory sound quality.

The weighting section 40 applies a weighting function W(z) as represented by Equation (2) to the input speech unit and thereby generates a weighted speech unit.

$$W ( z ) = \frac{1 + {\sum }_{i = 1}^{p} {β}^{′} a ( i ) {z}^{- i}}{1 + {\sum }_{j = 1}^{p} {γ}^{j} a ( j ) {z}^{- j}} \qquad ( 2 )$$

Crosscorrelation

An crosscorrelation section 54 calculates a cross-correlation C(i) between the weighted speech unit sw(n) (n=1, . . . , N) supplied from the weighting circuit 40 and the impulse response hw (n) (n=1, . . . , N) supplied from the weighting impulse response section 35 by using the following equation (3), wherein N is the length of a speech unit.

$$C ( i ) = {\sum }_{n = 1}^{N} sw ( n ) hw ( n - i ) \qquad ( 3 )$$

Autocorrelation

The autocorrelation section 50 calculates an autocorrelation R (i,j) of the impulse response hw (n) (n=1, . . . , N) supplied from the weighting impulse response section 35 by the following equation (4).

$$R ( i , j ) = {\sum }_{n = 1}^{N} hw ( n - i ) hw ( n - j ) \qquad ( 4 )$$

Pulse Position Search

The pulse position search section 59 uses the cross-correlations C(i) and the autocorrelations R(i,j) to successively determine the pulse position m(k) and the amplitude of a k-th pulse so as to minimize D(k) as represented by Equation (5) while incrementing k until an end flag has been received from a pulse count controller 65.

$$D ( k ) = \frac{{⌈ C ( m ( k ) ) - {\sum }_{i = 1}^{k - 1} g ( i ) R ( m ( k ) , m ( i ) ) ]}^{2}}{R ( m ( k ) , m ( k ) )} \qquad ( 5 )$$

In the equation (5), g(i) is the amplitude of an i-th pulse, which is calculated as follows:

$$g ( k ) = C ( m ( k ) ) - {{\sum }_{i - 1}^{k1} g ( i ) R ( m ( k ) , m ( i ) )}_{R ( m ( k ) , m ( k ) )} \qquad ( 6 )$$

Minimizing D(k) is equivalent to minimizing a distance between the input speech unit and a signal which is obtained by a string of pulses exciting the synthesis filter.

Coded data of pulse positions obtained by the pulse position search section 59 are supplied to the multiplexer 85. The amplitude of each pulse obtained by the pulse position search section 59 is supplied to a maximum amplitude selector 70 and a predetermined number of amplitude SQ (scalar quantization) coders 80a-80b.

Pulse Count Control

A SNR calculator 60 uses the following equation (7) to calculate a signal-to-noise ratio SNR(k) at a pulse number k based on the autocorrelations R(i,j) and cross-correlations C(i). The pulse position search section 59 and the SNP calculator 60 may use the pulse number k which is incremented one by one. The calculated, SNR(k) is successively output to the pulse count controller 65. The pulse position search section 59 and the SNR calculator 60 increment k one by one until the end flag has been received from the pulse count controller 65.

$$SNR ( k ) = 10 log [ \frac{{P}_{in}}{{P}_{in} - \frac{{[ C ( m ( k ) ) - {\sum }_{i = 1}^{k - 1} g ( i ) R ( m ( k ) , m ( i ) ) ]}^{2}}{R ( m ( k ) , m ( k ) )}} ] , \qquad ( 7 )$$

wherein Pᵢₙ is the power of an input speech unit.

The pulse count controller 65 compares the received SNR(k) with a predetermined threshold value. When the SNR(k) exceeds the predetermined threshold value at k=Np, the pulse count controller 65 sends the end flag to the pulse position search section 59 and the SNR calculator 60. The pulse count controller 65 also sends a coded pulse sound (Np−1) to the multiplexer 85.

The pulse count can be selected from a plurality of predetermined discrete values k, for example, integral multiples of 5, resulting in the reduced number of bits necessary for the transmission of the pulse count.

Amplitude Coding

The maximum amplitude selector 70 selects the maximum value from the amplitudes of the searched pulses by the pulse position search section 59. A maximum amplitude SQ coder 75 codes the maximum amplitude selected by the maximum amplitude selector 70 by means of scalar quantization (SQ) and sends the coded maximum amplitude to the multiplexer 85.

The quantized maximum amplitude is supplied to the amplitude SQ coders 80a-80b. There are provided as many amplitude SQ coders as the possible pulses, and the amplitude SQ coder corresponding to a pulse codes the amplitude of the pulse calculated by the pulse position search section 59 by means of scalar quantization, provided that the pulse amplitude coded by the maximum amplitude SQ coder 75 is withdrawn from the coding of each amplitude SQ coder. The coded amplitudes of pulses are output to the multiplexer 85.

The multiplexer 85 receives the coded LSP coefficients from the LSP coder 25, the coded pulse position data from the pulse position search section 59, the pulse count data from the pulse count controller 65, the coded amplitude data of pulses from the amplitude SQ coders 80a-80b, and the coded maximum amplitude data from the maximum amplitude SQ coder 75 to produce a bit stream. The bit stream is sent to the compressed speech unit database 235.

The same function as the compression section as shown in FIG. 2 can be implemented by, for example, a program-controlled processor such as a CPU (Control Processing Unit) running appropriate programs stored in a ROM (Read Only Memory). The same function can also be implemented by special-purpose circuits.

1.2) Decompression

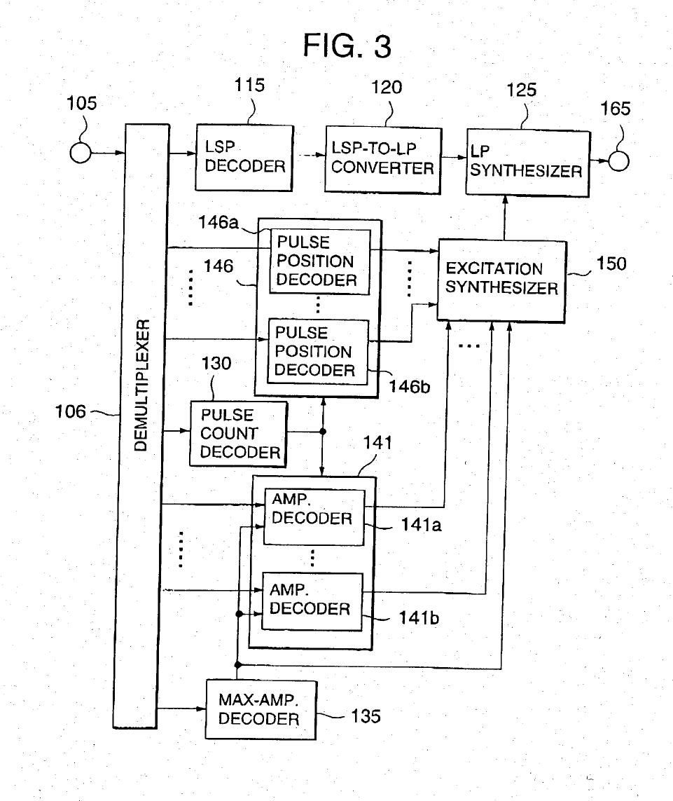

Referring to FIG. 3, the decompression section receives a bit stream of compressed speech unit data through an input terminal 105. The bit stream is demultiplexed by a demultiplexer 106 to produce coded LSP coefficients, coded pulse position data, coded pulse count data, coded amplitude data, and coded maximum amplitude data.

An LSP decoder 115 decodes the coded LSP coefficients to output the LSP coefficients to an LSP-LP converter 120. The LSP-LP converter 120 converts the LSP coefficients to LP coefficients, which is outputted to an LP synthesizer 125.

The pulse count data is supplied to a pulse count decoder 130. The pulse count decoder 130 decodes the coded pulse count data to produce the pulse count (Np−1), which is outputted as a control signal to a position decoding section 146 and an amplitude decoding section 141.

The coded pulse position data are supplied to the position decoding section 146 including as many pulse position decoders 146a-146b as the possible pulses. According to the pulse count (Np−1) receive from the pulse count decoder 130, (Np−1) ones among the pulse position decoders 146a-146b are made active to decode the coded pulse position data to produce the pulse position data. Alternatively, the position decoding section 146 may generate (Np−1) pulse position decoders therein according to the pulse count (Np−1).

The coded maximum amplitude data is supplied to a maximum amplitude decoder 135. The maximum amplitude decoder 135 decodes the coded maximum amplitude data to output the maximum amplitude to the amplitude decoding section 141.

The coded amplitude data are supplied to the amplitude decoding section 141 including as many amplitude decoders 141a-141b as the possible pulses. According to the pulse count (Np−1) received from the pulse count decoder 130, (Np−1) ones among the amplitude decoders 141a-141b are made active to decode the coded amplitude data to produce the amplitude data using the maximum amplitude. Alternatively, the amplitude decoding 141 may generate (Np−1) amplitude decoders therein according to the pulse count (Np−1).

An excitation synthesizer 150 receives the pulse positions from the pulse position decoding section 146 and the pulse amplitudes from the amplitude decoding section 141, and generates an excitation signal which is composed of pulses each having the pulse amplitudes at the pulse positions. The LP synthesizer 125 synthesizes a speech signal by the excitation signal exciting an LP filter composed of the LP coefficients received from the LSP-LP converter 120. A post-filter for emphasizing spectrum peaks may also be applied to the synthesized speech signal in order to improve auditory voice quality.

The same function as the decompression section as shown in FIG. 3 can be implemented by, for example, a program-controlled processor such as a CPU (Central Processing Unit) running appropriate programs stored in a ROM (Road Only Memory). The same function can also be implemented by special-purpose circuits.

Second Embodiment

2.1) Compression

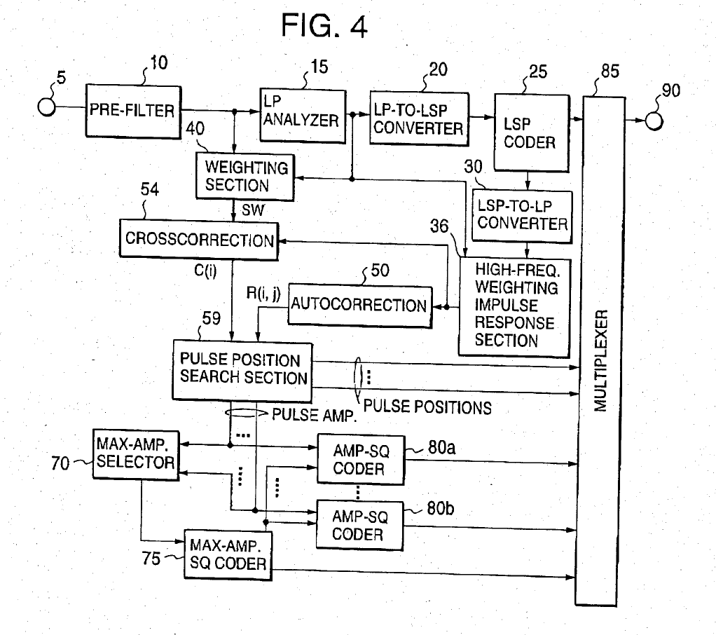

Referring to FIG. 4, a compression section according to a second embodiment of the present invention is further provided with a pre-filter 10 and a high-frequency weighting impulse response section 36 in place of the weighting impulse response section 35 of FIG. 2. Accordingly, the pre-filter 10 and the high-frequency weighting impulse response section 36 will be mainly described in detail. The other blocks similar to those described with reference to FIG. 2 are denoted by the same reference numerals and the details will be omitted.

The pre-filter 10 applies a weight function Wₚᵣₑ(z)=1−z⁻¹ to input speech units and outputs weighted input speech units to the LP analyzer 15 and the weighting section 40.

The high-frequency weighting impulse response section 36 generates the weighting synthesis filter Hw2(z) as represented by the following equation (8) by use of the quantized LP coefficients a\hat{ }(i) (i=1, . . . p) supplied from the LSP-LP converter 30, the LP coefficients a(i) (i=1, . . . p) supplied from the LP analyzer 15, and a weighting function W_{percep}(z)=1/(1−z⁻¹) having inverse characteristics of the weighting function Wₚᵣₑ(z) of the pre-filter 10. The high-frequency weighting impulse response section 36 calculates impulse response of the weighting synthesis filter Hw2(z). The weighting function W_{percep}(z)=1/(1−z⁻¹) is used for improving auditory voice quality.

$$Hw2 ( z ) = \frac{1}{1 + {\sum }_{j = 1}^{p} \hat{a} ( j ) {z}^{- j}} \cdot \frac{1 + {\sum }_{i = 1}^{p} {β}^{i} a ( i ) {z}^{- i}}{1 + {\sum }_{j = 1}^{p} {γ}^{j} a ( j ) {z}^{- j}} \cdot \frac{1}{1 - {z}^{- 1}} \qquad ( 8 )$$

In the above equation (8), p is the order of LP analysis, β and γ are coefficients which satisfy 0<γ<β≧1 and are used for adjusting the weighting for improving auditory voice quality. Incidentally, such weighting can also be employed in the compression section of the first embodiment as shown in FIG. 2.

2.2) Decompression

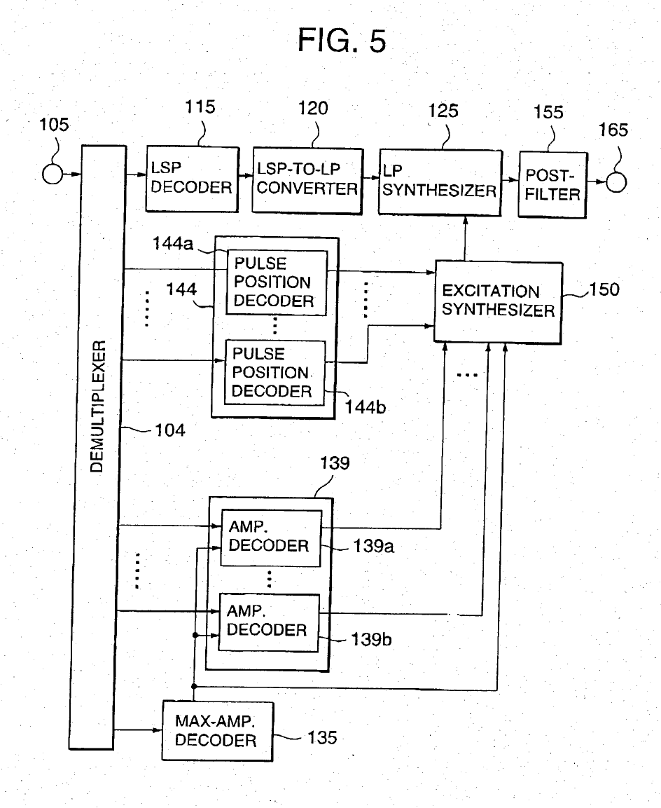

Referring to FIG. 5, a decompression section according to the second embodiment of the present invention is further provided with a post-filter 155. Accordingly, the post-filter 155 will be mainly described in detail. The other blocks similar to those described with reference to FIG. 3 are denoted by the same reference numerals and the details will be omitted.

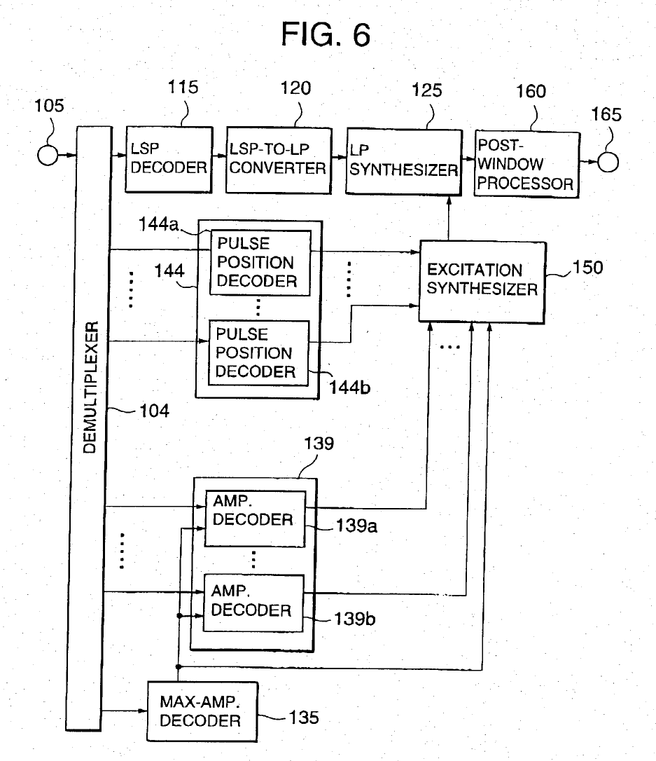

The post-filter 155 applies the weighting function W_{percep}(z) =1/(1−z⁻¹) to each speech unit synthesized by the LP synthesizer 125 and outputs the weighted speech unit through the output terminal 165. Incidentally, such weighting can also be employed in the decompression section of FIG. 3. The decompression sections of FIGS. 6 and 9 will be explained below.

As described above, the weighting function Wₚᵣₑ(z)=1−z⁻¹ for weighting a high-frequency range is applied to the input speech units, and the weighting function W_{percep}(z)=1/(1−z⁻¹) is employed in a criterion function that is used for the calculation of the pulse positions and pulse amplitudes.

Such weighting operations cause an input speech unit Y(z) to be approximated by a signal obtained by applying the low-frequency range weighting function to a reproduced speech unit Ŷ(z) as shown in the following equation (9).

D(z)=W_{percep}(τ)[Wₚᵣₑ(z)Y(z)−\hat{Y}(z)]=[Y(z)−W_{percep}(z)\hat{Y}(z)] (9)

Consequently, the high-frequency range can be weighted in the evaluation of a reproduced speech unit Ŷ(z).

Meanwhile, in the decompression processing, the weighting W_{percep}(z) is applied in order to cancel out the effects of the weighting Wₚᵣₑ(z) which has been used in the compression process.

Third Embodiment

Referring to FIG. 6, a decompression section according to a third embodiment of the present invention is further provided with a post-window processor 101. Accordingly, the post-window processor 160 will be mainly described in detail. The other blocks similar to those described with reference to FIG. 3 are denoted by the same reference numerals and the details will be omitted.

The post-window processor 160 applies a time window to each speech unit synthesized by the LP synthesizer 125 and outputs the speech unit through the output terminal 165.

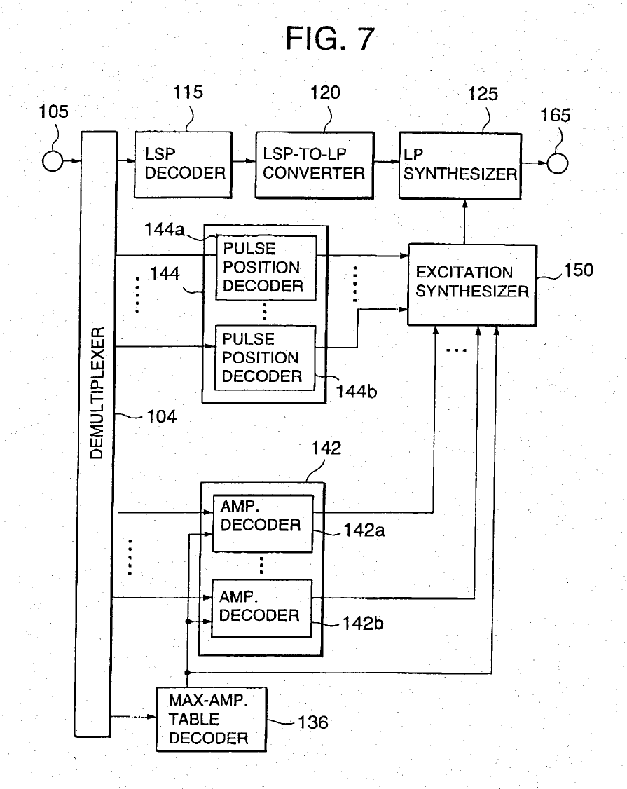

The time window is used to set the starting point and endpoint of each speech unit to 0. As such a time window or window function, Hamming window, Hanning window, etc. which are used as a time window for LP coefficient analysis, can be employed. The window function can also be employed in the decompression sections of FIGS. 3, 5 and 7. The decompression section of FIG. 7 will be explained below.

Fourth Embodiment

Referring to FIG. 7, a decompression section according to a fourth embodiment of the present invention is provided with a maximum amplitude table decoder 136 and an amplitude decoding section 142, which are different from the maximum amplitude decoder 135 and the amplitude decoding, section 141 of FIG. 3. Accordingly, the maximum amplitude table decoder 136 and the amplitude decoding section 142 with be mainly described in detail. The other blocks similar to those described with reference to FIG. 3 are denoted by the same reference numerals and the details will be omitted.

The maximum amplitude table decoder 136 is provided with a scalar quantization table which has been generated in advance. When receiving coded maximum amplitude data from the demultiplexer 104, the maximum amplitude table decoder 136 uses the scalar quantization table to decode the coded maximum amplitude and outputs the maximum amplitude to the excitation synthesizer 150. The maximum amplitude table decoder 136 also sends the code indicating the decoded maximum amplitude to the amplitude decoding section 142.

The amplitude decoding section 142 has a plurality of table amplitude decoders 142a-142b each corresponding to the pulses other than the maximum-amplitude pulse. Each of the table amplitude decoders 142a-142b receives corresponding coded amplitude data from the demultiplexer 104 to output its pulse amplitude to the excitation synthesizer 150.

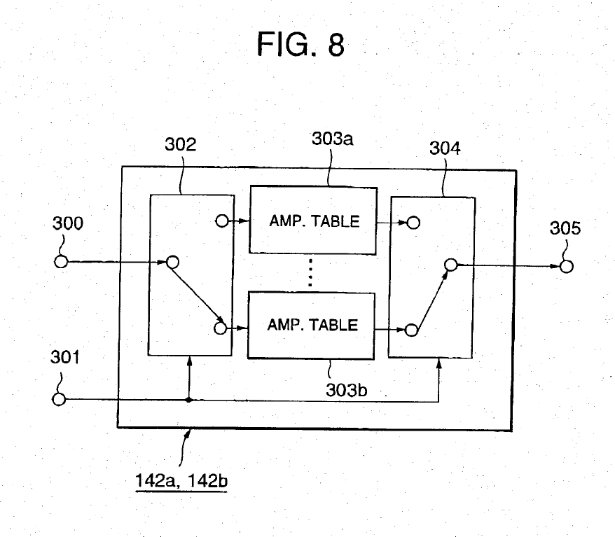

As shown in FIG. 8, each of the table amplitude decoders 142a-142b has a plurality of amplitude tables 303a-303b, each of which has been designed for each level of the maximum amplitude which would be obtained by the maximum amplitude table decoder 136. A pair of switches 302 and 304 selects one of the amplitude tables 303a-303b to decode corresponding coded amplitude data inputted at an input terminal 300 to output corresponding amplitude data through an output terminal 305.

The selection operation of the switches 302 and 304 is controlled depending on the code indicating the decoded maximum amplitude inputted from the maximum amplitude table decoder 136 through a control signal input terminal 301.

When inputting the code indicating the decoded maximum amplitude inputted from the maximum amplitude table decoder 136, an appropriate one of the amplitude tables 303a-303b is selected depending on the level of the decoded maximum amplitude and is used to decode the corresponding coded amplitude data.

As set forth hereinabove, in the speech synthesis system and speech synthesis method in accordance with the present invention, the following advantages can be achieved.

First, the number of pulses to be used for the compression/decompression of each speech unit can be varied so that a required number of pulses can be set for each speech unit. By the variable setting of the number of pulses, the compression ratio of an excitation signal is increased and thereby the compression ratio of the speech unit database can be raised. This causes an increased number of speech units stored in the compressed speech unit database.

Second, by use of the evaluation function having a heavier weight on the high-frequency range, the accuracy of quantization in the high-frequency range can be improved and the dropouts of information in the high-frequency range can be reduced.

Third, by the application of a time window for setting the starting point and endpoint of each speech unit to 0 to each decompressed speech unit, the discontinuity occurring when the speech units are combined together can be eliminated and thereby the quality of synthesized speech can be improved.

While the present invention has been described with reference to the particular illustrative embodiments, it is not to be restricted by those embodiment but only by the appended claims. It is to be appreciated that those skilled in the art can change or modify the embodiments without departing from the scope and spirit of the present invention.

What is claimed is:

1. A device for compressing an input signal composed of speech units for speech synthesis to produce a compressed output signal, comprising:
a filter information extractor for extracting information of a filter to be used for speech synthesis from a speech unit;
a pulse information extractor for extracting information of pulses for exciting the filter from the speech unit;
a controller for determining the number of pulses for each of the speech units depending on characteristics of the speech unit; and
an output producer for producing the compressed output signal from the information of the filter, the information of the pulses and the determined number of the pulses for each of the speech units.

2. The device according to claim 1, wherein the controller determines the number of the pulses depending on compression quality of the speech unit.

3. The device according to claim 1, wherein the controller selects one of a plurality of predetermined discrete values as the number of the pulses depending on compression quality of the speech unit.

4. A device for compressing an input signal composed of speech units for speech synthesis to produce a compressed output signal, comprising:
a high-frequency enhancement filter for inputting a speech unit to produce a filtered speech unit;
a filter information extractor for extracting information of a filter to be used for speech synthesis from the filtered speech unit;
a pulse information extractor for extracting information of pulses for exciting the filter from the filtered speech unit using a weighting function which has inverse characteristics of the high-frequency enhancement filter; and
an output producer for producing the compressed output signal from the information of the filter and the information of the pulses.

5. The device according to claim 4, further comprising:
a controller for determining the number of pulses for each of the speech units depending on characteristics of the filtered speech unit,
wherein the compressed output signal includes the determined number of pulses.

6. The device according to claim 5, wherein the controller determines the number of the pulses depending on compression quality of the filtered speech unit.

7. A device for decompressing a compressed signal composed of compressed speech units to produce original speech units, wherein each of the compressed speech units includes coded information of a filter to be used for speech synthesis, coded information of pulses for exciting the filter, and coded pulse count information of the number of pulses that have been used for compression of an original speech unit, comprising:
a pulse count decoder for decoding the coded pulse count information to produce the number of pulses; and
a speech unit decoder for decoding the coded filter information and the coded pulse information based on the number of pulses.

8. A device for decompressing a compressed signal composed of compressed speech units to produce original speech units, wherein each of the compressed speech units is obtained based on a filtered speech unit obtained by high-frequency enhancement filtering of an original speech unit, each of the compressed speech units including coded information of a filter to be used for speech synthesis and coded information of pulses for exciting the filter, comprising:
a speech unit decoder for decoding the coded filter information and the coded pulse information to produce a decompressed speech unit; and
a low-frequency enhancement filter for inputting the decompressed speech unit to produce the original speech unit.

9. A device for decompressing a compressed signal composed of compressed speech units to produce original speech units, wherein each of the compressed speech units includes coded information of a filter to be used for speech synthesis and coded information of pulses for exciting the filter, comprising:
a speech unit decoder for decoding the coded filter information and the coded pulse information to produce a decompressed speech unit; and
a post-window section for applying a window function to each decompressed speech unit, wherein the window function sets a starting point and endpoint of the decompressed speech unit to zero.

10. A device for decompressing a compressed signal composed of compressed speech units to produce original speech units, wherein each of the compressed speech units includes coded information of a filter to be used for speech synthesis and coded pulse amplitude information and coded pulse position information of pulses for exciting, the filter, wherein the coded pulse amplitude information includes coded maximum amplitude information and other coded amplitude information, comprising:
a first decoder for decoding the coded information of the filter to produce information of the filter;
a position decoder for decoding the coded pulse position information of the pulses to produce pulse position information of the pulses; and
an amplitude decoder for decoding the coded pulse amplitude information of the pulses to produce pulse amplitude information of the pulses,
wherein the amplitude decoder comprises:
a first decoder having a first table, for decoding the coded maximum amplitude information to produce a maximum amplitude of the pulses; and
a plurality of second decoders for decoding the other coded amplitude information to produce amplitudes of each pulse other than the maximum amplitude, wherein each of the second decoders comprises:
a plurality of second tables for decoding the other coded amplitude information of a corresponding pulse, wherein each of the plurality of second tables is provided for a different level of a maximum amplitude of pulses; and
a selector for selecting one of the plurality of second tables for decoding the other coded amplitude information depending on a level of the decoded maximum amplitude of the pulses.

11. A speech synthesis system comprising:
a compression device for compressing a plurality of speech units for speech synthesis to produce a compressed speech units;
a database for retrievable storing compressed speech units received from the compression device;
a decompression device for decompressing a plurality of compressed speech units retrieved from the database,
wherein the compression device comprises:
a filter information extractor for extracting information of a filter to be used for speech synthesis from a speech unit;
a pulse information extractor for extracting information of pulses for exciting the filter from the speech unit;
a controller for determining the number of pulses for each of the speech units depending on characteristics of the speech unit; and
an output producer for producing the compressed speech units from the information of the filter, the information of the pulses and the determined number of pulses for each of the speech units, and
the decompression device comprises:
a pulse count decoder for decoding the coded pulse count information to produce the number of pulses; and
a speech unit decoder for decoding the coded filter information and the coded pulse information based on the number of pulses; and
a synthesizer for synthesizing the filter information and the pulse information to produce decompressed speech units.

12. The speech synthesis system according to claim 11, wherein the decompression device further comprises:
a post-window section for applying a window function to each decompressed speech unit, wherein the window function sets a starting point and endpoint of the decompressed speech unit to zero.

13. The speech synthesis system according to claim 11, wherein the decompression device further comprises:
a first decoder for decoding the coded information of the filter to produce information of the filter;
a position decoder for decoding the coded pulse position information of the pulses to produce pulse position information of the pulses;
an amplitude decoder for decoding the coded pulse amplitude information of the pulses to produce pulse amplitude information of the pulses,
wherein the amplitude decoder comprises:
a first decoder having a first table, for decoding the coded maximum amplitude information to produce a maximum amplitude of the pulses; and
a plurality of second decoders for decoding the other coded amplitude information to produce amplitudes of each pulse other than the maximum amplitude, wherein each of the second decoders comprises:
a plurality of second tables for decoding the other coded amplitude information of a corresponding pulse, wherein each of the plurality of second tables is provided for a different level or a maximum amplitude of pulses; and
a selector for selecting one of the plurality of second tables for decoding the other coded amplitude information depending on a level of the decoded maximum amplitude of the pulses.

14. A speech synthesis system comprising:
a compression device for compressing a plurality of speech units for speech synthesis to produce a compressed speech units;
a database for retrievably storing compressed speech units received from the compression device;
a decompression device for decompressing a plurality of compressed speech units retrieved from the database,
wherein the compression device comprises:
a high-frequency enhancement filter for inputting a speech unit to produce a filtered speech unit;
a filter information extractor for extracting information of a filter to be used for speech synthesis from the filtered speech unit;
a pulse information extractor for extracting information of pulses for exciting the filter from the filtered speech unit using a weighting function which has inverse characteristics of the high-frequency enhancement filter; and
an output producer for producing the compressed speech units from the information of the filter and the information of the pulses, and
the decompression device comprises:
a speech unit decoder for decoding the coded filter information and the coded pulse information;
a synthesizer for synthesizing the filter information and the pulse information to produce decompressed speech units; and
a low-frequency enhancement filter for inputting the decompressed speech units to produce output speech units.

15. The speech synthesis system according to claim 14, wherein the decompression device further comprises:
a post-window section for applying a window function to each of the output speech units, wherein the window function sets a starting point and endpoint of the output speech unit to zero.

16. The speech synthesis system according to claim 14, wherein the decompression device further comprises:
a first decoder for decoding the coded information of the filter to produce information of the filter;
a position decoder for decoding the coded pulse position information of the pulses to produce pulse position information of the pulses;
an amplitude decoder for decoding the coded pulse amplitude information of the pulses to produce pulse amplitude information of the pulses,
wherein the amplitude decoder comprises:
a first decoder having a first table, for decoding the coded maximum amplitude information to produce a maximum amplitude of the pulses; and
a plurality of second decoders for decoding the other coded amplitude information to produce amplitudes of each pulse other than the maximum amplitude, wherein each of the second decoders comprises:
a plurality of second tables for decoding the other coded amplitude information of a corresponding pulse, wherein each of the plurality of second tables is provided for a different level of a maximum amplitude of pulses; and
a selector for selecting one of the plurality of second tables for decoding the other coded amplitude information depending on a level of the decoded maximum amplitude of the pulses.

17. A method for compressing an input signal composed of speech units for speech synthesis to produce a compressed output signal, comprising the steps of:
extracting information of a filter to be used for speech synthesis from a speech unit;
extracting information of pulses for exciting the filter from the speech unit;
determining the number of pulses for each of the speech units depending on characteristics of the speech unit; and
producing the compressed output signal from the information of the filter, the information of the pulses and the determined number of pulses for each of the speech units.

18. A method for compressing an input signal composed of speech units for speech synthesis to produce a compressed output signal, comprising the steps of:
applying a high-frequency enhancement filter to a speech unit to produce a filtered speech unit;
extracting information of a filter to be used for speech synthesis from the filtered speech unit;
extracting information of pulses for exciting the filter from the filtered speech unit using a weighting function which has inverse characteristics of the high-frequency enhancement filter; and
producing the compressed output signal from the information of the filter and the information of the pulses.

19. A method for decompressing a compressed signal composed of compressed speech units to produce original speech units, each of which includes coded information of a filter to be used for speech synthesis, coded information of pulses for exciting the filter and coded pulse count information of the number of pulses that have been used for compression of an original speech unit, comprising the steps of:
decoding the coded pulse count information to produce the number of pulses; and
decoding the coded filter information and the coded pulse information based on the number of pulses.

20. A method for decompressing a compressed signal composed of compressed speech units to produce original speech units, wherein each of the compressed speech units is obtained based on a filtered speech unit obtained by high-frequency enhancement filtering of an original speech unit, each of the compressed speech units including coded information of a filter to be used for speech synthesis and coded information of pulses for exciting the filter, comprising the steps of:
decoding the coded filter information and the coded pulse information to produce a decompressed speech unit; and
applying a low-frequency enhancement filter to the decompressed speech unit to produce the original speech unit.

21. A method for decompressing a compressed signal composed of compressed speech units to produce original speech units, wherein each of the compressed speech units includes coded information of a filter to be used for speech synthesis and coded information of pulses for exciting the filter, comprising the steps of:
decoding the coded filter information and the coded pulse information to produce a decompressed speech unit; and
applying a window function to each decompressed speech unit, wherein the window function sets a starting point and endpoint of the decompressed speech unit to zero.

22. A speech synthesis method comprising the steps of:
compressing a plurality of speech units for speech synthesis to produce a compressed speech units;
retrievably storing compressed speech units received from the compression device; and
decompressing a plurality of compressed speech units retrieved from the database,
wherein the compression step comprises the steps of:
extracting information of a filter to be used for speech synthesis from a speech unit;
extracting information of pulses for exciting the filter from the speech unit;
determining the number of pulses for each of the speech units depending on characteristics of the speech unit; and
producing the compressed speech units from the information of the filter, the information of the pulses and the determined number of pulses for each of the speech units, and
the decompression step comprises the steps of:
decoding the coded pulse count information to produce the number of pulses; and
decoding the coded filter information and the coded pulse information based on the number of pulses; and
synthesizing the filter information and the pulse information to produce decompressed speech units.

23. A speech synthesis method comprising the steps of:
compressing a plurality of speech units for speech synthesis to produce a compressed speech units;
retrievably storing compressed speech units received from the compression device; and
decompressing a plurality of compressed speech units retrieved from the database,
wherein the compression step comprises the steps of:
applying a high-frequency enhancement filter to a speech unit to produce a filtered speech unit;
extracting information of a filter to be used for speech synthesis from the filtered speech unit;
extracting information of pulses for exciting the filter from the filtered speech unit using a weighting function which has inverse characteristics of the high-frequency enhancement filter; and
producing the compressed output signal from the information of the filter and the information of the pulses, and
the decompression step comprises the steps of:
decoding the coded filter information and the coded pulse information to produce a decompressed speech unit; and
applying a low-frequency enhancement filter to the decompressed speech unit to produce the original speech unit.
